(19) United States
(12) Patent Application Publication
(10) Pub. No.: US 2014/0265571 A1
(43) Pub. Date: Sep. 18, 2014

(54) LED FACILITIES LIGHTING SYSTEM

(71) Applicants: John Bogart, Oxford, CT (US); Frank Cassandra, Lake Worth, FL (US); Sergio Bastiani, Weston, FL (US)

(72) Inventors: John Bogart, Oxford, CT (US); Frank Cassandra, Lake Worth, FL (US); Sergio Bastiani, Weston, FL (US)

(21) Appl. No.: 14/209,078

(22) Filed: Mar. 13, 2014

Related U.S. Application Data
(60) Provisional application No. 61/779,544, filed on Mar. 13, 2013.

(51) Int. Cl. H05B 33/08; H02J 9/00

(52) U.S. Cl. CPC H05B 33/0809; H02J 9/00
USPC 307/24; 315/185 R

(57) ABSTRACT

A facilities lighting system includes a power supply and an AC/DC converter in electrical communication with the power supply. A plurality of lighting fixtures is in electrical communication with one another in series wherein at least one of the plurality of lighting fixtures is in electrical communication with the AC/DC converter. At least one LED lighting member is installed in the at least one of the plurality of lighting fixtures. In one embodiment, the lighting member is an LED tubular bulb such as an LED T8 tube.

### CROSS-REFERENCE TO RELATED APPLICATIONS

This application claims the benefit of U.S. Provisional Patent Application Ser. No. 61/779,544 filed on Mar. 13, 2013, which is incorporated herein by reference in its entirety.

### TECHNICAL FIELD

The present invention is directed to lighting systems using light-emitting diode (“LED”) technology, and, more particularly, to LEDs configured for use in facilities lighting systems.

### BACKGROUND

Existing electrical wiring at facilities typically require that power circuits are brought geographically throughout the facility. For example, a single circuit breaker may be dedicated to an area of offices and provide power for wall outlets, computers, copiers, printers and other office equipment, as well as lights. All of the equipment, including incandescent lights, are designed for and draw power from the sole source. The most common lighting application in such a facility involves the use of one or more fluorescent bulbs or tubes installed in a troffer. A troffer is a rectangular light fixture that is typically installed in a modular dropped ceiling grid and is designed to accommodate standard fluorescent tubes. Fluorescent tubes are generally designated by a code such as “T#” where the “T” indicates that the shape of the bulb is tubular, and the number “#” indicates the diameter of the tube in eighths of an inch. For example, a T8 Tube represents a fluorescent tubular bulb having a one inch diameter; and a T12 Tube represents a fluorescent tubular bulb having a 1.5 inch diameter. A typical facility lighting fixture includes two T8 Tubes, each tube terminating in a quick disconnect configuration having two protruding pins. A ballast is required to boost the energy to the fixture so that the fluorescent tubes can power on appropriately.

Light Emitting Diode (“LED”) lights have been available to replace some fluorescent tubes as a more energy efficient product for the lighting needs of a factory or warehouse. However, LED lights inherently are designed to operate off of a Direct Current (DC) circuit. A preferred power source for LEDs is much like household batteries. The power is designed to originate at the source and travel to the application. In contrast, Alternating Current (AC) circuits deliver power from the source to the application as well as delivering power downline to the next series of applications. Substantially the entire electrical infrastructure of existing facilities is wired via AC circuits. Therefore, a move to LED lighting products within an existing AC infrastructure requires some type of conversion of the power infrastructure.

One known system involves converting AC to DC in the ballast of the fixture and installing an LED T8 tube that is designed for DC input. It is common for these models to convert power from 120 volts AC (“VAC”) to 290 volts DC (“VDC”). However, the existing ballast must first be bypassed as the ballast function could damage or destroy the LED lighting products. The ballast must be rewired to provide the appropriate energy to supply LED lights. The re-wiring of the ballast requires the conversion of AC to DC and therefore a power supply also must be wired and installed. As a result, the ballast and the entire fixture are rewired for use in a manner for which it was not intended. It is known that this type of installation is unreliable and problematic.

Another known system involves using a specially designed LED T8 Tube that has AC/DC conversion capability built into the tube. Such a tube tube is designed to handle power input to a standard fixture. Although the LED T8 Tube can accommodate the 120 VAC input, the existing lighting fixture still must be rewired. For example, the ballast still must be bypassed as the boost in energy is not needed and will damage the LED T8 Tube. Moreover, the conversion of AC to DC is performed inside the light tube itself. Such power conversion generates heat in each and every tube installed throughout the facility. Such heat will reduce the life of the tube as well. In addition, the presence of the power conversion device in the tube increases the overall weight of the tube. The heavier tube puts additional strain on the conventional two-pin housing of the tube and often the increased weight exceeds the tolerance of the housing. Therefore, an unsafe installation exists.

The use of fluorescent tubes in facilities lighting systems remains problematic because such tubes are not energy efficient and the mercury that present in the tube is a health and environmental hazard. The known solutions involving the installation of LED T8 Tubes within existing fixture housings outfitted with ballasts are not economical, at best, and are known to be unsafe and unreliable, and cannot deliver an appropriate life-cycle cost savings particularly in a warehouse or factory setting.

There also is a drive to utilize solar power for lighting. There are many limitations that keep facilities from exclusively using solar power or from using it in a more reliable way. One of the issues keeping the technology from advancing is the existence of losses from power source conversion. Industrial-sized solar panels collect energy and transmit that energy to a power carrier at 380 VDC. In order to use the power transmitted by such solar panels in conventional lighting systems, the power must to be inverted from DC to AC. For typical facilities lighting applications, such inversion is generally from 380 VDC to 120 VAC. When LED T8 Tubes are used, the power is converted from AC back to DC inside the tube itself or in the ballast section of the fixture via the use of a power supply or rectifier. Losses at every point of the energy transmission—inversion from 380 VDC to 120 VAC and conversion from 120 VAC to DC voltage at the fixture or in the LED T8 Tube are significant. It is known that such losses are potentially in the range of 25%. Thus, there is an industry need for the ability to capture solar energy at 380 VDC and step down that voltage to a DC rating suitable for powering LED T8 Tubes without unnecessary and redundant inversion or conversion which is known to result in losses.

### SUMMARY

In one aspect, the present invention resides in a facilities lighting system comprising: a power supply; an AC/DC converter in electrical communication with the power supply; a plurality of lighting fixtures in electrical communication with one another in series wherein at least one of the plurality of lighting fixtures is in electrical communication with the AC/DC converter; and at least one LED lighting member installed in the at least one of the plurality of lighting fixtures.

In another aspect, the present invention resides in a facilities lighting system comprising: a solar power supply; a transformer in electrical communication with the power supply, the transformer receiving a DC power input and transmitting a DC power output and an AC power output; a power storage unit in electrical communication with the transformer and thereby receiving the AC power output; a control unit for sensing the DC power output and drawing power from the power storage unit if the DC power output is below a threshold; a plurality of lighting fixtures in electrical communication with one another in series wherein at least one of the plurality of lighting fixtures is in electrical communication with the transformer and thereby receiving the DC power output; and at least one LED lighting member installed in the at least one of the plurality of lighting fixtures.

### BRIEF DESCRIPTION OF THE DRAWINGS

FIG. 1 is a schematic diagram of one embodiment of an LED facilities lighting system of the present invention.

FIG. 2 is a schematic diagram of another embodiment of an LED facilities lighting system of the present invention.

FIG. 3 is a schematic diagram of yet another embodiment of an LED facilities lighting system of the present invention.

### DETAILED DESCRIPTION

An LED facilities lighting system in accordance with the present invention is designated generally by the reference number 10 and is hereinafter referred to as “lighting system 10.” As is shown in FIGS. 1 and 2, the lighting system 10 comprises one or more lighting fixtures 12 in electrical communication with one another in a line or series. Each lighting fixture includes a corresponding troffer 15. In one embodiment, each of the lighting fixtures 12 comprises a passive lighting fixture having no ballast installed therein. In one embodiment, the lighting system 10 comprises a plurality of lighting fixtures 12, for example “n” lighting fixtures including lighting fixtures 12₁ and 12₂, through 12ₙ, electrically connected in series via a first electrical conduit 20A to form a low voltage lighting circuit 60. The lighting system 10 provides for the conversion of AC to DC in line prior to the first fixture 12₁ in the plurality of lighting fixtures and then the transmission of DC power throughout a dedicated lighting circuit 50 to power the lighting fixtures 12 in electrical communication therewith (e.g. fixtures 12₁ through ¹²ₙ).

Each of the lighting fixtures 12 has one or more LED lighting members 30 installed therein. Each LED lighting member 30 includes a plurality of LED bulbs 32 installed therein. In one embodiment, the LED lighting member 30 comprises an LED bulb such as an LED T8 tube 36. In one embodiment, lighting fixtures 12₁ through 12ₙ each have two LED T8 tubes 36 installed therein. In one embodiment, the LED lighting member 30 comprises a plurality of LED bulbs 32 connected in a series on an LED bar 38, or rail or rod or the like, thereby eliminating the need for T8 tubes and the maintenance and replacement costs associated therewith. In one embodiment, the plurality of lighting fixtures 12₁ through 12ₙ each have two LED bars 38 installed therein. As further discussed below, the lighting system 10 is designed to more efficiently handle the conversion from AC to DC and power the LED lighting members 30 to standard design specification T8 Tubes while exhibiting increased inherent safety and efficiency characteristics.

A power supply such as, for example, a typical main electrical panel 14 receives electrical input from an external electrical power source 13, such as for example transmission lines from the local power grid, lines transmitting power generated at the facility, or the like, to supply power to all applications located in a certain area of a facility. The electrical panel 14 typically comprises a single-phase electrical panel having predominantly 120 VAC circuits respectively designated for lighting circuits and comprises a plurality of circuit breakers 16. In one embodiment of the present invention, one circuit breaker 16A is in electrical communication with a dedicated lighting circuit 50 to power the plurality of lighting fixtures 12 in electrical communication therewith. In one embodiment, another circuit breaker 16B is in electrical communication with another dedicated lighting circuit 50 to power the plurality of lighting fixtures 12 in electrical communication therewith. In one embodiment, each dedicated lighting circuit 50 comprises a 20 amp circuit.

The electrical panel 14 is in electrical communication with an AC/DC converter 18 via a second electrical conduit 20B. The AC/DC converter 18 is installed in line at a point before the first lighting fixture 12₁ of the plurality of lighting fixtures 12; and is in electrical communication with lighting fixture 12₁ via a third electrical conduit 20C. While electrical panel 14 is shown and described for providing electrical input to the lighting system 10, the present invention is not limited in this regard as other types of electrical power sources, such as for example an electrical generator, can be employed without departing from the broader aspects of the present invention While electrical conduits 20A, 20B and 20C are shown and described as separate electrical conduits, the present invention is not limited in this regard as such electrical conduits may comprise less than three conduits or more than three conduits without departing from the broader aspects of the present invention. While electrical conduits 20A, 20B and 20C are shown and described as conduits, the present invention is not limited in this regard as electrical communication between the described features of the invention may be provided by, for example, standard American wire gauge (AWG) electric wiring or cable, existing three-wire infrastructure or two-wire infrastructure, or commercially available wiring or cable meeting respective building codes, without departing from the broader aspects of the present invention.

The AC/DC converter 18 converts 120 Volts AC to one or more DC secondary lines, for example the third electrical conduit 20C. The voltage converted by the AC/DC converter 18 and carried to one or more of the secondary lines ranges from about 24 VDC to about 300 VDC. In one embodiment, the voltage converted by the AC/DC converter 18 and carried to one or more of the secondary lines is in the range of about 290 volts. In one embodiment, the AC/DC converter 18 includes a protective housing 18A. In one embodiment, the protective housing 18A includes a heat dissipation mechanism or means 18B. Thus, the AC/DC converter 18 performs an AC to DC conversion efficiently and dissipates any heat generated in a controlled environment. Because the wattage requirement of the lighting system 10 is significantly less than known lighting systems comprising conventional T8 tubes, one dedicated lighting circuit 50 in electrical communication with one AC/DC converter 18 is capable of providing power to a significantly higher quantity of LED T8 tubes 36 installed in the lighting fixtures 12.

As further shown in FIG. 2, one embodiment 10′ of the AC/DC converter 18 includes a primary side 19A and a secondary side 19B. In one embodiment, the AC/DC converter 18 converts voltage input to the primary side 19A from a range of about 120 VAC to about 300 VAC. In one embodiment, the AC/DC converter 18 includes more than one secondary side 19B such that the AC/DC converter 18 supplies power to more than one lighting circuit 60. In one embodiment, the AC/DC converter 18 includes eight secondary sides 19B such that the AC/DC converter 18 supplies power to eight dedicated lighting circuits 50. In one embodiment, the AC/DC converter 18 converts 120 VAC to 132 VDC. In one embodiment, the AC/DC converter 18 is wall-mounted.

The LED lighting members 30 are rated for a voltage input/output in a range from about 80 VDC to about 300 VDC. In one embodiment, the LED lighting members 30 are rated for a voltage input/output in a range of about 290 VDC. In one embodiment, the LED lighting members 30 are rated for a voltage input/output in a range as low as about 24 VDC. Each of the LED T8 tubes 36 comprises a conventional two-pin housing 34 installed at each end thereof such that the tubes may be easily installed within and removed from a standard lighting fixture having a conventional two-pin electrical connector installed at each end thereof. In one embodiment, each of the LED bars 38 comprises a conventional two-pin housing 34 installed at each end thereof.

Another LED facilities lighting system in accordance with the present invention is designated generally by the reference number 100 and is hereinafter referred to as “lighting system 100.” The lighting system 100 is shown in FIG. 3 and is similar to lighting system 10 shown in FIG. 1, thus like elements are given a like element number preceded by the numeral 1. Lighting system 100 optimizes the use of solar energy as an alternative power supply and is designed to also receive power input from an industrial-sized solar panel 102. A building outfitted with a plurality of such panels may have a portion of them, for example 40% to 60%, dedicated to facilities lighting. Each solar panel 102 transmits power to one or more dedicated lighting circuits 150 to power one or more lighting fixtures 112 in electrical communication therewith.

Each lighting fixture 112 includes a corresponding troffer 115. In one embodiment, each of the lighting fixtures 112 comprises a passive lighting fixture having no ballast installed therein. In one embodiment, the lighting system 100 comprises a plurality of lighting fixtures 112, for example, “n” lighting fixtures including lighting fixtures 112₁ through 112ₙ, electrically connected in series via a first electrical conduit 120A to form a low voltage lighting circuit 160. Each of the lighting fixtures 112 has one or more LED lighting members 130 installed therein. Each of the LED lighting members 130 includes a plurality of LED bulbs 132 installed therein. In one embodiment, the LED lighting member 130 comprises an LED bulb such as an LED T8 tube 136. In one embodiment, lighting fixtures 112₁ through 112ₙ each have two LED T8 tubes 136 installed therein. In one embodiment, the LED lighting member 130 comprises a plurality of LED bulbs 32 connected in a series on an LED bar 138, or rail or rod or the like, thereby eliminating the need for T8 tubes and the maintenance and replacement costs associated therewith. In one embodiment, the plurality of lighting fixtures 112₁ through 112ₙ each have two LED bars 138 installed therein. Each of the LED T8 tubes 136 comprises a conventional two-pin housing 134 installed at each end thereof such that the tubes may be easily installed within and removed from a standard lighting fixture having a conventional two-pin electrical connector installed at each end thereof. In one embodiment, each of the LED bars 138 comprises a conventional two-pin housing 134 installed at each end thereof.

A transformer 104 receives electrical input from the solar panel 102 via an electrical conduit 120D. The transformer 104 is constructed similarly to the AC/DC 18 of the lighting system 10 and includes corresponding protection and heat dissipation features. In one embodiment, the transformer 104 includes controlling technology 106 (defined below). In one embodiment, the solar panel 102 transmits an electrical output of about 380 VDC to the transformer 104. The transformer 104 serves as a “Smart Box” and receives the electrical input rated at about 380 VDC and such voltage is stepped down by the transformer 104 to a lower DC voltage suitable for facilities lighting applications. In one embodiment, the transformer 104 transforms 380 VDC to a first voltage output in a range from about 80 VDC to about 300 VDC. In one embodiment, the first voltage output is in a range of about 290 VDC. In one embodiment, the first voltage output is in a range as low as about 24 VDC. The transformer 104 is installed in line at a point before the first lighting fixture 112₁ in the plurality of lighting fixtures 112; and is in electrical communication with lighting fixture 112₁ via an electrical conduit 120C. While the solar panel 102 is described as having an electrical output of about 380 VDC, the present invention is not limited in this regard as the solar panel 102 can have an output less than about 380 VDC or more than about 380 VDC without departing from the broader aspects of the present invention.

In one embodiment, the transformer 104 transmits excess voltage at about 380 VDC to a battery backup or power storage unit 108 via an electrical conduit 120E. In one embodiment, the transformer 104 converts excess voltage to 120 VAC and transmits such voltage directly to the power grid 113 as is typical with standard solar installations. In one embodiment, the storage unit 108 is in electrical communication with an electrical panel 114 that comprises a plurality of circuit breakers 116. The controlling technology 106 of the transformer 104 automatically senses when the electrical input received from the solar panel 102 is not sufficient to power the dedicated lighting circuit 150 and draws power from the storage unit 108 or the electrical panel 114 to provide appropriate power to the circuit via an electrical conduit 120B.

In one embodiment, the controlling technology 106 of the transformer 104 comprises an automated sensing selector switch to selectively control the flow of power received and transmitted by the transformer 104. In one embodiment, the controlling technology 106 measures the power transmitted by the transformer 104 to the plurality of lighting fixtures 112 via the electrical conduit 120C. If insufficient power is detected, the source of power is switched to draw power from one or both of the storage unit 108 and the electrical panel 114. In one embodiment, the controlling technology 106 of the transformer 104 comprises a manual selector switch to selectively control the flow of power received and transmitted by the transformer 104. For example, power may be selectively provided from the solar panel 102 to the lighting fixtures 112 along a path defined by the electrical conduit 120C, from the solar panel 102 to the storage unit 108 along a path defined by the electrical conduit 120E, and from the storage unit 108 to the lighting fixtures 112 along a path defined by the electrical conduits 120B and 120C.

Use of the lighting system 100 allows a facility to optimize the energy provided by the solar panel 102 to power the lighting fixtures 112 installed in the facility without the substantial power losses incurred and heat generated from the inversion of VDC to VAC and the subsequent conversion of VAC back to VDC. Such use of the lighting system 100 provides for the elimination of the power inverter which results in a substantial cost savings. Moreover, power inversion and conversion points typically are the points in the lighting system that fail. For example, the power supply or inverter may either wear out or cause other equipment to wear out prematurely. By reducing the number of conversions from many (i.e., at every light fixture) to once at the transformer 104, the lighting system 100 comprises a simpler, more efficient system that requires less maintenance and provides extended life and delivers life-cycle cost savings. Use of the lighting system 100 further provides for dedicated solar panels for lighting applications which improves the control and monitoring of energy usage in the facility. The lighting system 100 is designed to reduce losses that are incurred in conventional solar installations by approximately 25%-35%; thereby maximizing solar energy and making it a more competitive and economical solution for supplying power for facilities lighting systems.

Use of the lighting fixture 10, 100 provides for excluding the use of ballasts in such fixtures 12, 112. Since ballasts are the most common fail point in conventional fluorescent lighting, the lighting fixtures of the present invention exhibit a longer life than conventional lighting fixtures and require substantially less maintenance. As a result, the lighting fixtures of the present invention are substantially more economical than conventional lighting fixtures. Use of the lighting fixtures of the present invention eliminates the need to convert power input at the light fixture or the LED tube T8 tube and, as a result, the fixture and the tube are not exposed to the heat generated by such power conversion which extends the life of the fixture and the tube. In addition, by converting AC to DC only once rather than at every light fixture or in every tube, the light fixtures and the tubes run more efficiently and thereby consume less energy and cost less to operate. In addition, shock hazards at each lighting fixture are eliminated and the overall lighting fixture weighs less than a conventional lighting fixture.

Use of the lighting fixture 10, 100 provides a streamlined lighting system which minimizes trouble shooting that exists when one or several lights are out of service in conventional lighting systems. In addition, the lighting fixtures of the present invention eliminate harmonics and noise that is present at each light in conventional lighting systems. The lighting fixtures of the present invention also provide for immediate powering-up rather than the warm-up period required by conventional lighting systems.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A facilities lighting system comprising:
a power supply;
an AC/DC converter in electrical communication with the power supply;
a plurality of lighting fixtures in electrical communication with one another in series wherein at least one of the plurality of lighting fixtures is in electrical communication with the AC/DC converter; and
at least one LED lighting member installed in the at least one of the plurality of lighting fixtures.

2. The facilities lighting system of claim 1 wherein the at least one LED lighting member comprises an LED T8 tube.

3. The facilities lighting system of claim 1 further comprising two LED lighting members installed in each of the plurality of lighting fixtures.

4. The facilities lighting system of claim 1 wherein the at least one lighting fixture comprises no ballast.

5. The facilities lighting system of claim 1 wherein the at least one LED lighting member is rated for a voltage input/output in a range from about 80 VDC to about 300 VDC.

6. The facilities lighting system of claim 1 wherein the at least one LED lighting member is rated for a voltage input/output in a range of about 290 VDC.

7. The facilities lighting system of claim 1 wherein the at least one LED lighting member is rated for a voltage input/output in a range as low as about 24 VDC.

8. A facilities lighting system comprising:
a solar power supply;
a transformer in electrical communication with the power supply, the transformer receiving a DC power input and transmitting a DC power output and an AC power output;
a power storage unit in electrical communication with the transformer and thereby receiving the AC power output;
a control unit for sensing the DC power output and drawing power from the power storage unit if the DC power output is below a threshold;
a plurality of lighting fixtures in electrical communication with one another in series wherein at least one of the plurality of lighting fixtures is in electrical communication with the transformer and thereby receiving the DC power output; and
at least one LED lighting member installed in the at least one of the plurality of lighting fixtures.

9. The facilities lighting system of claim 8 wherein the at least one LED lighting member comprises an LED T8 tube.

10. The facilities lighting system of claim 8 further comprising two LED lighting members installed in each of the plurality of lighting fixtures.

11. The facilities lighting system of claim 8 wherein the at least one lighting fixture comprises no ballast.

12. The facilities lighting system of claim 8 wherein the at least one LED lighting member is rated for a voltage input/output in a range from about 80 VDC to about 300 VDC.

13. The facilities lighting system of claim 8 wherein the at least one LED lighting member is rated for a voltage input/output in a range of about 290 VDC.

14. The facilities lighting system of claim 8 wherein the at least one LED lighting member is rated for a voltage input/output in a range as low as about 24 VDC.

15. The facilities lighting system of claim 8 wherein the solar power supply has an output of about 380 VDC.
